(19) United States
(12) Patent Application Publication
(10) Pub. No.: US 2007/0170164 A1
(43) Pub. Date: Jul. 26, 2007

(54) OUTER-LOOP CONTROL FOR USE WITH NICKEL AND DUPLEX STAINLESS STEEL FILLER ALLOYS AND CARBON DIOXIDE CONTAINING SHIELDING GAS

(75) Inventor: Jeffrey T. Nadzam, Westlake, OH (US)

Correspondence Address: PAUL, HASTINGS, JANOFSKY & WALKER LLP, P.O. BOX 919092, SAN DIEGO, CA, 92191-9092, US

(73) Assignee: Lincoln Global, Inc., City of Industry, CA (US)

(21) Appl. No.: 11/626,621

(22) Filed: Jan. 24, 2007

Related U.S. Application Data
(60) Provisional application No. 60/761,366, filed on Jan. 24, 2006.

(51) Int. Cl. B23K 9/09

(52) U.S. Cl. 219/130.51

(57) ABSTRACT

A method of welding with high nickel content and duplex stainless steel electrodes using adaptive outer loop control to change at least one of a peak current or pulse frequency of a pulse waveform used for welding. The pulse waveform is changed based on a detected change in contact tip to work distance between the electrode and the work piece. The arc generated between the work piece and the electrode is shielded by a shielding gas which contains carbon dioxide and an inert gas.

### CROSS-REFERENCE TO RELATED APPLICATION

This application is based upon and claims the benefit of priority from U.S. Provisional Application 60/761,366 filed on Jan. 24, 2006 in the United States Patent and Trademark Office, the disclosure of which is incorporated herein by reference in its entirety.

### BACKGROUND OF THE INVENTION

1. Field of the Invention

Devices, systems, and methods consistent with the invention relate to welding with higher nickel and duplex stainless steel electrodes.

2. Description of the Related Art

During the welding process an electrode is advanced toward a work piece and melted in order to create the weld. The distance between the electrode and the work piece is referred to as the contact tip to work distance (i.e., “CTWD”). When welding is performed by hand, as opposed to automated welding, constant changes to the CTWD is inherent in the process. AS the CTWD changes the arc length and energy changes, which can affect the quality of the weld. This is particularly true in non-adaptive weld systems, in which the arc length or energy remains unchanged during the welding process.

Conventional welding systems for welding with high nickel (i.e. above about 55% nickel content) and duplex stainless steel electrodes have an arc which is non-adaptive. Because of the non-adaptive nature of welding with high nickel and duplex stainless steel electrodes out-of-position welding is difficult and leads to problems with the finished weld quality.

These problems occur when the arc length becomes too long (i.e. over ½″), degrading the weld quality, and often occurs when welding in any of the 3G, 3F, 4G and 4F weld positions. Common problems which occur due to non-adaptive nature of this welding are: incomplete fusion defects which cause costly weld cutouts and weld repairs, the inability to manipulate the welding torch to accommodate narrower welding grooves, and the creation of excessive arc energy which exceeds heat input requirements for finished welds on A255, 2205 duplex stainless steel alloy base materials and/or high nickel containing base materials. Because of these problems out-of-position welding with these electrode types is not typically done.

In other welding situations, the arc length during out-of-position welding is regulated using outer loop controls, which aid in maintaining a usable arc length. However, when welding with high nickel and duplex stainless steel electrodes a 100% inert shielding gas (typically argon or argon and helium) is used, and the use of the 100% inert shielding gas prevents the use of outer loop control when welding with high nickel and duplex stainless steel electrodes.

Because of the increasing importance of corrosion resistant welding applications, namely in flue gas desulphurization fabrication, Corrosion Resistant Alloy pipes chemical and refinery process piping, and the food and pharmaceutical industry, there is an need to be able to weld with high nickel and duplex stainless steel electrodes in out-of-position welding positions.

### BRIEF SUMMARY OF THE INVENTION

In one aspect of the invention, there is provided an outer loop control for use with high nickel or duplex stainless steel electrodes using a shielding gas containing carbon dioxide,

In another aspect of the invention, there is provided a double outer loop control for use with high nickel or duplex stainless steel electrodes using a shielding gas containing carbon dioxide.

The above stated aspects, as well as other aspects, features and advantages of the invention will become clear to those skilled in the art upon review of the following description.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates an embodiment of a control system used with the present invention;

FIG. 2 illustrates a single pulsed waveform in accordance with an embodiment of the invention; and

FIG. 3 illustrates a flow chart showing a method of an embodiment of the present invention.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

An exemplary embodiment of the present invention employs at least one outer loop control to regulate one of the pulsed waveform frequency or the pulse peak current in an adaptive fashion to control the arc length along with a shielding gas having about 0.05% to about 2.5% carbon dioxide and inert gas, when welding with high nickel or duplex stainless steel electrodes.

Another exemplary embodiment of the present invention employs at least two outer loop controls to regulate, which regulate respectively, pulsed waveform frequency and the pulse peak current in an adaptive fashion to control the arc length along with a shielding gas having about 0.05% to about 2.5% carbon dioxide and inert gas, when welding with high nickel or duplex stainless steel electrodes.

Each of these embodiments will be discussed in detail below, but the present invention is not limited to these embodiments.

In a first embodiment of the present invention a shielding gas having carbon dioxide is used in conjunction with an adaptive outer loop control which controls one of the pulsed waveform frequency or the pulse peak current to optimize arc length for changing CTWD.

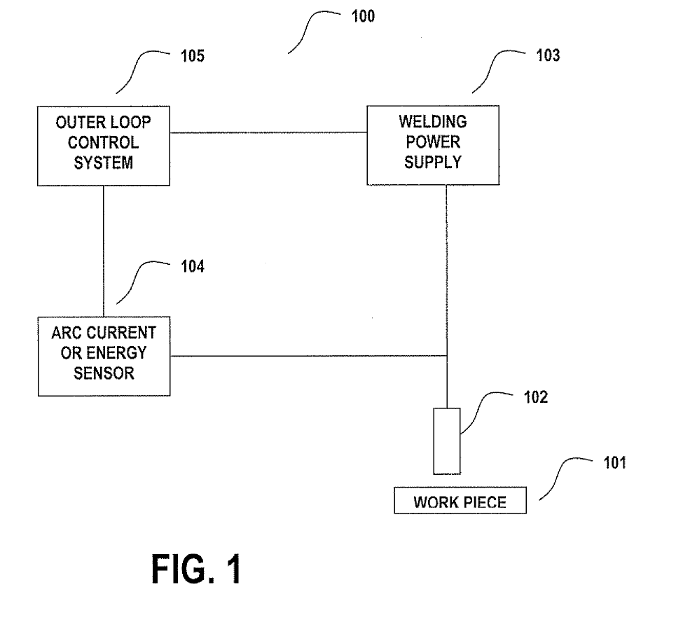

As shown in FIG. 1 a simplified embodiment of a welding system 100 employing the present invention is shown. In this system 100 a weld piece 101 is being welded via a welding gun 102 or device which is coupled to a welding power source 103. The welding gull 102 and welding power source 103 can be of any conventionally known construction or configuration, and the present invention is not limited in this regard. However, it is noted that with regard to welding with high nickel and duplex stainless steel electrodes typically a GMAW (gas metal arc welding) welding system is employed.

During welding a shielding gas is provided from the shielding gas source 106. As discussed above, in conventional applications where high nickel and duplex stainless steel electrodes are used the shielding gas is entirely inert (100% inert gas). However, in an embodiment of the present invention carbon dioxide is added to the shielding gas. In an embodiment of the present invention the shielding gas contains about 0.05% to about 2.5% carbon dioxide. In a further embodiment of the present invention the gas contains about 1.5 to about 2% carbon dioxide. The remaining gas is an inert gas and can be argon or a combination of argon and helium. In an embodiment of the invention in which both argon and helium is used, there is about 30 to about 60% helium and the balance in argon, and in a further embodiment of the invention there is about 50% to about 60% helium and the balance in argon.

The use of carbon dioxide in the shielding gas permits the use of the adaptive outer loop control of the present invention, while not compromising the corrosion resistance of the weld. During welding the carbon dioxide introduces small of amounts of oxygen into the arc due to the processes of dissociation and recombination. The introduction of this oxygen permits the use of adaptive outer loop control, which will be discussed more fully below. Additionally, it is noted that during welding with this procedure nickel and chromium oxides form on the surface of the welds and the bevel face of the groove joints that require removal prior to additional welding.

As shown in FIG. 1 the system 100 further includes a welding current sensor 104 which detects the welding current of the arc generated between the welding gun 102 and the work piece 101. The welding current sensor 104 can be of any known or conventional type and monitors the current of the arc of the weld. Coupled to the welding current sensor 104 is a outer loop control system 105. During welding the outer loop control system 104 adjusts one of the pulse frequency and the peak current of the pulse waveform used for welding based on the current detected by the sensor 104. Thus the outer loop control system 104 controls the welding power supply 103 in such a way to control the pulse peak current and or the pulse frequency to optimize arc length for welding.

In another embodiment of the present invention, the outer loop control system 105 controls the welding power supply 103 to adjust both of the pulse frequency and peak current of the pulse waveform to optimize arc length.

It is noted that although the sensor 104, control system 105 and power supply 103 are shown graphically as separate components in FIG. 1 the present invention is not limited in this regard. Specifically, it is contemplated that each of these components are integrally formed within a single unit, such as the welder control unit (not shown). Further, it is also contemplated that the sensor 104 and control system 105 be a single unit, where the control system 105 receives the current feedback directly, as opposed to through a sensing device (as shown). The present invention is not limited in this regard as it is contemplated that those of ordinary skill in the art recognize various methodologies and topologies to implement this aspect of the present invention.

The operation of an embodiment of the present invention will not be explained.

During the welding operation (when welding with high nickel or duplex stainless steel electrodes) the CTWD changes between the work piece 101 and the welding gun 102. This is particularly true in out-of-position welding. As this distance changes the energy of the welding arc, or arc length, changes. This change occurs at least partially, because of the change in resistance between the work piece 101 and the welding gun 102, as the distance changes. For example, as the distance grows the resistance increases. These changes affect the arc current and arc energy and can result in an inferior weld, requiring replacement. As discussed previously, in conventional welding applications using high nickel and duplex stainless steel electrodes the welding systems are unable to adapt to the changes in arc length and energy brought about by changes in CTWD.

In an embodiment of the present invention, the change in current is detected by the sensor 104. Based on the detected current, the control system 105 controls the power supply 103 to adjust the peak current and/or the pulse frequency of the current waveform to compensate for this change in current, due to CTWD changes. The control system 105 controls the power supply 103 to ensure that the required arc length and/or arc energy (for the specific application) is being maintained to ensure an acceptable weld is performed. Thus, the present invention contemplates using outer loop adaptive control for either the pulse frequency or the peak current, or both, to maintain proper arc length and arc energy during welding with electrodes which are either high nickel or duplex stainless steel electrodes.

In an embodiment of the invention, the control system 105 controls the power supply using a look-up table type control system in which settings for either of the pulse frequency and/or peals current is determined based on predetermined settings which are a function of at least the detected current and the electrode being used. In an additional embodiment, the control system 105 employs a feedback system (not shown) which operates to maintain the arc length/arc energy within an operational range. The present invention is not limited in this regard, and any known method or system of monitoring the arc current and controlling the power supply 103 based on that current can be used.

Although the above discussion is directed to monitoring the current of the welding arc, in another embodiment of the present invention the arc voltage, or a combination of current and voltage may be monitored to provide the same result. Further, in an additional alternative embodiment, the adaptive outer loop control for both the peak current and the pulse frequency or controlled by the control system 105. However, it is also contemplated that the outer loop control systems are independent of each other such that they employ different control systems 105 and or sensors 104.

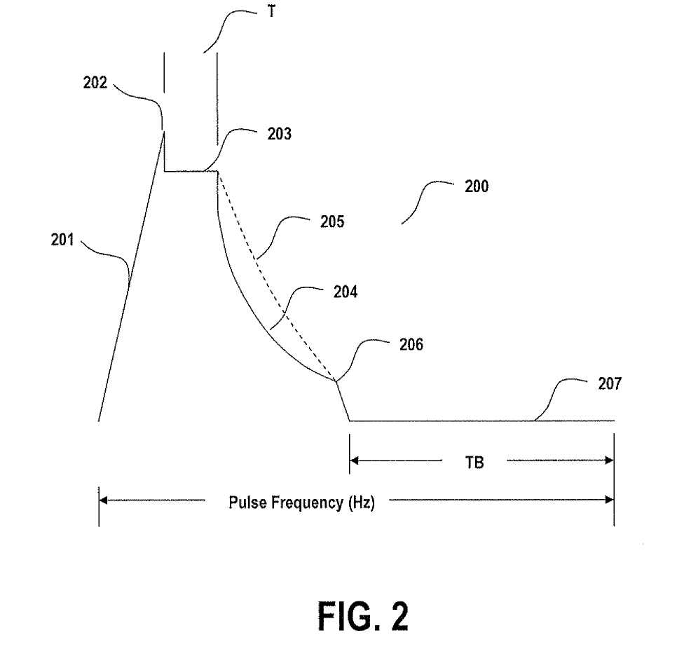

Referring to FIG. 2, an exemplary embodiment of a pulse current waveform 200 of the present invention is depicted. As shown, the pulse current waveform 200 has a number of discrete sections or portions, which will be discussed below.

At the beginning of the pulse is the front flank 201, where the pulse current is increased from a background level 207 to a level 202 as fast as possible. The level 202 is higher than the pulse peak current level 203 because of the inherent nature of welding power supplies, where the current bypasses the desired peak level 203. This overshoot is rapidly corrected to the peak current level 203, which is the peak current used for the welding operation. The peak current level 203 is maintained for a duration T, also referred to as the peak current time or peak time. After the peak time T, the current is tailed out 204 to the step-off current 206. The tail out speed 205 is reflected by the dashed line. After reaching the step-off current 206 the current is dropped to a background level 207, which is maintained for a duration TB. After the time TB, the front flank 201 of the following pulse is begun and the process is repeated. The pulse frequency is determined based on the time from the beginning of the front flank 201 of a pulse to the end of the duration TB.

In accordance with an embodiment of the invention, either the peak current 203 or the pulse frequency, or a combination of both is adjusted based on the current of the arc between the work piece 101 and the welding gun 102 (namely the electrode not shown). For example, it is contemplated that during operation, as the arc length increases (namely the electrode is being pulled away from the work piece) and the arc energy drops, the adaptive outer loop control(s) increase the pulse frequency or the peak current, or both, to compensate for the energy loss in the arc.

During operation of the present invention, the adaptive outer loop controls of either the pulse frequency or peak current, or both, are used to optimize arc length or weld energy during welding while the CTWD changes. Of course the optimal levels and specific alterations made to the pulse waveform is a function of the welding being performed and the electrode being used. However, it is noted that if the peak current value decreases to a nominal value, or otherwise becomes too low, the metal transfer from the electrode becomes more globular, which is undesirable. On the other hand, if the frequency becomes to rapid then the background time TB becomes too minimal and arc performance will fail. Similar disadvantages occur when peak current is increased or decreased beyond optimal performance limits.

Thus, an embodiment of the present invention optimizes the welding arc energy by rapidly changing the pulse frequency and/or peak current depending on changes in CTWD, when used in conjunction with a shielding gas having at least some carbon dioxide within the gas.

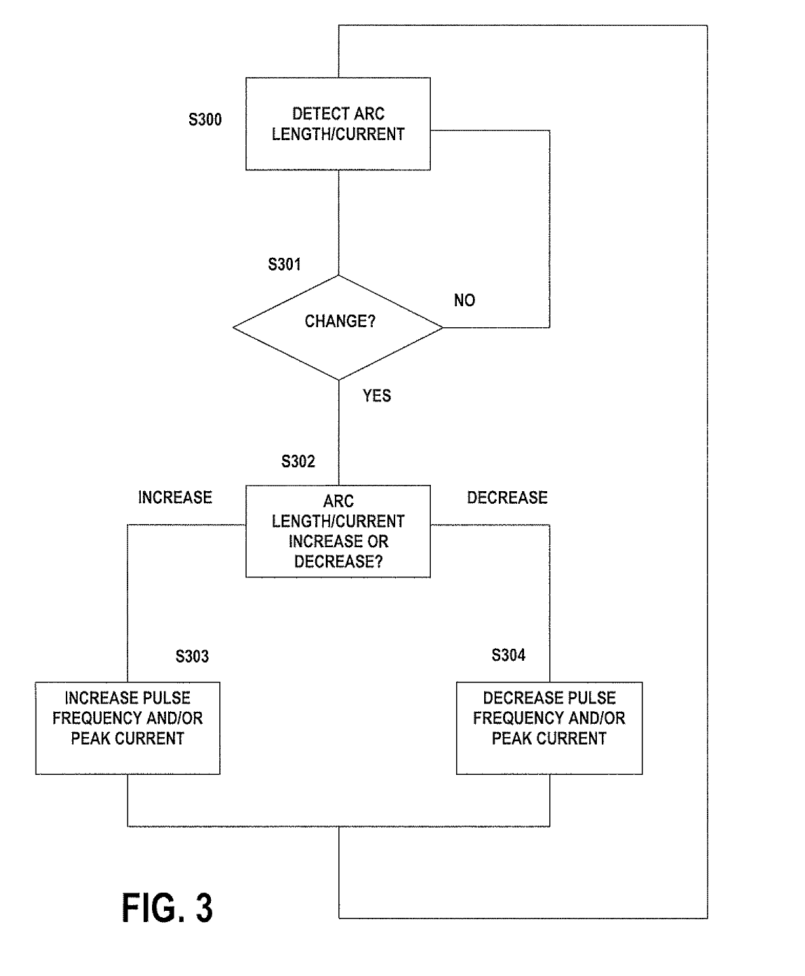

FIG. 3 illustrates a flow diagram of a method according to an exemplary embodiment of the present invention. Of course, the present invention is not limited in this regard, as FIG. 3 is intended to only be exemplary in nature.

In FIG. 3, in operation S300 the arc length of a pulse is detected and at operation S301 a determination is made as to whether or not there has been a change in the arc length from the previous pulse, which would result from a change in CTWD. If no change has been made, operation S300 is repeated until such time a change is detected. If a change has occurred, at operation S302 a determination is made as to whether the arc length has increased or decreased. If the arc length has increased, at operation S303 the control system 105 increases the pulse frequency or peak current of the pulse, or both, to compensate for the energy loss due to the increase in CTWD (causing the increased arc length). If a decrease in arc length is detected, at operation S304 the control system 105 decreases the pulse frequency or peak current of the pulse, or both, to compensate for the increase in energy due to the decrease in CTWD (causing the decreased arc length). After the operation is completed, and whatever adjustment to be made has been made, the operation is repeated as long as the welding operation continues.

Although the above embodiment has been discussed with regard to monitoring the arc length, it is also contemplated that other aspects of the arc can be monitored. For example, in an alternative embodiment of the present invention, it is contemplated that the arc energy, arc current and/or arc voltage can be monitored in a similar fashion to achieve the same or similar result. It is further contemplated that all or any combination of the above arc characteristics can be monitored. There are commonly known means and methods used for monitored the characteristics of a welding arc, and the embodiments of the present invention contemplate employing those methods, including but not limited to monitoring the current and/or voltage through the electrode.

In an embodiment the present invention, the control system 105 monitors arc length and/or arc energy during the peak current time T of the pulse waveform and controls the power supply 103 based on changes detected during that portion of waveform. However, the present invention is not limited in this regard and it is contemplated that additional portions of the waveform can be monitored for the purposes of the present invention.

In a further embodiment of the present invention, the change in arc length or arc energy is monitored during every pulse. In an another embodiment of the present invention, the arc length or arc energy is monitored at every Nth pulse. Stated differently, it is contemplated that the present invention monitors the arc length or arc energy every N pulse, where N is a whole number greater than 1.

As discussed above, embodiments of the present invention use adaptive outer loop control to change the peak current or the frequency of the pulse waveform, or both, based on detected changes in the arc length. However, the present invention is not limited in this regard as it is contemplated that other aspects of the pulse waveform can also be changed based on detected changes in the arc length or energy. For example, in an additional embodiment of the present invention, it is contemplated that the control system 105 changes at least the peak current time T of the pulse waveform. In a further embodiment of the present invention, the background current and/or the background time TB may be changed. It is also contemplated that in additional embodiments of the present invention any combination of the above aspects of the waveform are controlled changed during the welding process.

In an embodiment of the present invention, it is contemplated that the control system 105 uses scale factors, or the like, for the aspects of the pulse waveform which are to be changed based on detected changes in the CTWD. For example, it is contemplated that the control system 105 uses scale factors, or the like, for any one (or any combination thereof) of the pulse frequency, the pulse peak current, the peak current time, the background time, and/or the background current. By employing scale factors, or the like, the control system 105 can ensure that an optimal arc length or energy is maintained during the welding process regardless of the changes to CTWD.

As indicated above, an embodiment of the present invention is directed with welding with high nickel and duplex stainless steel electrodes. It is understood that high nickel electrodes typically have a nickel content of about 55%, and includes electrodes having a Nickel-Chrome-Molybdenum (NiCrMo) composition, which are often used for anti-corrosion applications like those discussed previously. Examples of which include AWS ERNiCrMo-3, -4, -10 and -14 electrodes, and the like. With regard to the duplex stainless steel electrodes, it is understood that this is referring to both the First-Generation Duplex Grades and Second-Generation Duplex Grades (from the IMS—International Molybdenum Society), which have a composition of chrome, molybdenum, nitrogen, austenite and ferrite. The most common of these types are typically used for flue-gas desulphurization (FGD) applications, and include the Base Alloys 2205 and A255 (where the fillers are AWS ER2209, and ER NiCrMo-3 and LNM Zeron 100×, respectively).

By employing an embodiment of the present invention, the creation of weld spatter, which is typically using conventional techniques having a non-adaptive control, is mitigated. The reduction and/or mitigation of this weld spatter aids in preventing the acceleration of corrosion which can be caused by weld spatter when the proper CTWD is not maintained when using a conventional non-adaptive system.

The following tables shown examples of welding guidelines that may be used with exemplary embodiments of the present invention. Table 1 is for welding with a duplex stainless steel and electrode, whereas Table 2 is for a high nickel electrode.

TABLE 1
0.045″ (1.2 mm) ER2209 Duplex Welding Guideline for 2G and 3G positions
Butt Weld: Single Bevel 45°
Shielding Gas - 55% He + 43% Ar + 2% CO₂

| | | Wire Feed Speed | | | | Travel Speed |
|---|---|---|---|---|---|---|
| Position | Pass | (ipm) | Trim Volts | Current | CTWD (in.) | (ipm) |
| 2G | Root | 125 | 22–24 | 90–100 | ¾ | 10 |
| 2G | Fill | 250–280 | 25–28 | 150–170 | ¾ | 15–20 |
| 2G | Cap | 250–280 | 25–28 | 150–170 | ¾ | 20–25 |
| 3G | Root | 80–135 | 19.5–22 | 85–110 | ¾ | 3–6 |
| 3G | Fill | 115–125 | 20–23 | 100–110 | ¾ | 3–6 |
| 3G | Cap (Vert. | 125–150 | 22–25 | 115–130 | ¾ | 10–15 |
| | Down) | | | | | |

TABLE 2
0.045″ (1.2 mm) LNM 60/20 ERNiCrMo-3 Welding Guideline for 2G and 3G positions
Butt Weld: Double V
Shielding Gas - 55% He + 43% Ar + 2% CO₂

| | | Wire Feed Speed | | | | Travel Speed |
|---|---|---|---|---|---|---|
| Position | Pass | (ipm) | Trim Volts | Current | CTWD (in.) | (ipm) |
| 2G | Root | 125 | 21–22 | 90–100 | ¾ | 10 |
| 2G | Fill | 250–280 | 25–28 | 150–180 | ¾ | 15–20 |
| 2G | Cap | 250–280 | 25–28 | 150–180 | ¾ | 20–25 |
| 3G | Root | 135–150 | 22–24 | 120–130 | ¾ | 3–6 |
| 3G | Fill | 135–150 | 22–24 | 120–130 | ¾ | 3–6 |
| 3G | Cap (Vert. | 135–150 | 22–24 | 125–135 | ¾ | 15–20 |
| | Down) | | | | | |

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A method of welding, the method comprising:
generating a welding arc between an electrode and a work piece using a pulse waveform;
shielding said welding arc with a shielding gas that contains carbon dioxide and at least one inert gas;
detecting a change in said arc between said electrode and said work piece;
changing at least a portion of the pulse waveform based on the detected change to create a second pulse waveform; and
generating an additional welding arc between said electrode and said work piece using said second pulse waveform,
wherein said electrode is either a duplex stainless steel electrode or a high nickel content electrode.

2. The method of welding of claim 1, wherein the amount of carbon dioxide in the shielding gas is in the range of about 0.05 to about 2.5%.

3. The method of welding of claim 1, wherein said detecting includes detecting a change in at least one of an arc length, an arc current, an arc energy and an arc voltage to detect said change in said arc.

4. The method of welding of claim 1, wherein both a pulse frequency and a peak current of said pulse waveform is changed to create said second pulse waveform.

5. The method of welding of claim 1, wherein at least one of a pulse frequency, peak current, peak current time, background current and background current time of said pulse waveform is changed to create said second pulse waveform.

6. The method of welding of claim 1, wherein the change in said arc is due to a change in distance between said electrode and said work piece.

7. The method of welding of claim 1, wherein said second pulse waveform is generated immediately following said pulse waveform.

8. The method of welding of claim 1, wherein said inert gas is made up of at least one of argon and helium.

9. A method of welding, the method comprising:
generating a welding arc between an electrode and a work piece using a pulse waveform;
shielding said welding arc with a shielding gas that contains about 0.05% to about 2.5% of carbon dioxide and at least one inert gas;
detecting a change in said arc between said electrode and said work piece, where said change is a result of a change in distance between said electrode and said work piece;
changing at least a portion of the pulse waveform based on the detected change to create a second pulse waveform; and
generating an additional welding arc between said electrode and said work piece using said second pulse waveform,
wherein said electrode is either a duplex stainless steel electrode or a high nickel content electrode.

10. The method of welding of claim 9, wherein said detecting includes detecting a change in at least one of an arc length, an arc current, an arc energy and an arc voltage to detect said change in said arc.

11. The method of welding of claim 9, wherein both a pulse frequency and a peak current of said pulse waveform is changed to create said second pulse waveform.

12. The method of welding of claim 9, wherein at least one of a pulse frequency, peak current, peak current time, background current and background current time of said pulse waveform is changed to create said second pulse waveform.

13. The method of welding of claim 9, wherein said second pulse waveform is generated immediately following said pulse waveform.

14. The method of welding of claim 9, wherein said inert gas is made up of at least one of argon and helium.

15. A method of welding, the method comprising:
generating a welding arc between an electrode and a work piece using a pulse waveform;
shielding said welding arc with a shielding gas that contains carbon dioxide and at least one inert gas;
detecting a change in said arc between said electrode and said work piece, where said change is a result of a change in distance between said electrode and said work piece;
changing at least one of a peak current and a pulse frequency of the pulse waveform based on the detected change to create a second pulse waveform; and
generating an additional welding arc between said electrode and said work piece using said second pulse waveform,
wherein said electrode is either a duplex stainless steel electrode or a high nickel content electrode.

16. The method of welding of claim 15, wherein the amount of carbon dioxide in the shielding gas is in the range of about 0.05 to about 2.5%.

17. The method of welding of claim 15, wherein said detecting includes detecting a change in at least one of an arc length, an arc current, an arc energy and an arc voltage to detect said change in said arc.

18. The method of welding of claim 15, wherein at least one of a peak current time, background current and background current time of said pulse waveform is also changed to create said second pulse waveform.

19. The method of welding of claim 15, wherein said second pulse waveform is generated immediately following said pulse waveform.

20. The method of welding of claim 15, wherein said inert gas is made up of at least one of argon and helium.
